(19) United States
(12) Patent Application Publication
(10) Pub. No.: US 2017/0103003 A1
(43) Pub. Date: Apr. 13, 2017

(54) PHYSICAL NETWORK SECURITY DEVICE AND CONTROL METHOD THEREFOR

(71) Applicant: Neusoft Corporation, Shenyang (CN)

(72) Inventor: Jian JIN, Shenyang (CN)

(21) Appl. No.: 15/270,851

(22) Filed: Sep. 20, 2016

(30) Foreign Application Priority Data
Oct. 9, 2015 (CN) 201510646658.4

(51) Int. Cl. G06F 11/20; G06F 9/455

(52) U.S. Cl. CPC G06F 11/203; G06F 9/45558; G06F 2201/805; G06F 2201/815; G06F 2009/45595

(57) ABSTRACT

A method for controlling a physical network security device and a physical network security device are provided. The physical network security device includes: a master virtual machine, a slave virtual machine and a physical network card; and the method includes: acquiring a running state of the master virtual machine and a running state of the slave virtual machine; controlling to switch a binding/unbinding between the master virtual machine and the physical network card and between the slave virtual machine and the physical network card if it is detected that a failure occurs on the master virtual machine; and controlling the slave virtual machine to work as a new master virtual machine and controlling the master virtual machine with the failure to work as a new slave virtual machine.

### FIELD

The present disclosure relates to a network security field, and more particularly relates to a method for controlling a physical network security device, and a physical network security device.

### BACKGROUND

In order to block an attack from an external network, a key node in the network system is typically provided with a network security device. With the development of network technology, the scale of business carried on the network becomes bigger and bigger, and the type of the business becomes more and more complicated. In order to deal with various businesses, functions of the network security device become more and more complicated accordingly, while requirements from users on the availability of network security device become higher and higher. The complexity of the network security device leads to various failures of the device due to various reasons, such that the user has to endure the risk caused by the network outage.

The high availability provides a method for handling the risk due to a single point of failure in the network. For example, for an enterprise having a firewall, all of the import and export data stream would pass through the firewall under the consideration of network security. At this point, the firewall is a single point connection. The network is interrupted once a failure occurs on the firewall. In the related art, a common mechanism providing a high availability is redundancy, i.e., a high availability may be provided by a redundancy of device or link. A common solution in the redundancy mechanism is hot-standby, i.e., a back-up group is composed of two physical devices with the same configuration. One physical device is used as a master device, and configured to provide network services in the normal situation. The other physical device is used as a slave device, and configured to take the place of the master device when a failure occurs on the master device, such that the service interruption may be avoided, thus improving the availability.

Due to the complexity of network security device, the reason causing a failure on the device is mainly about the software problem, such as a problem produced by an operating system, a hardware drive, a kernel module, a process in user mode or the like in the network security device. Although the problem produced by the software may be solved in a conventional hot-standby solution, the cost for this deployment is usually high, and the deployment and configuration are complicated.

### SUMMARY

The present disclosure aims to solve at least one of the above problems to some extent.

Accordingly, a first objective of the present disclosure is to provide a method for controlling a physical network security device. In this method, two virtual machines running respective network security systems are used, such that a switching between a master virtual network security system and a slave virtual network security system may be realized in a same physical hardware, and the availability as to the software problem is increased greatly. Further, compared with the hot-standby technology, the cost is reduced greatly.

A second objective of the present disclosure is to provide a physical network security device.

In order to achieve the above objectives, embodiments of a first aspect of the present disclosure provide a method for controlling a physical network security device. The physical network security device includes a master virtual machine, a slave virtual machine and a physical network card. The master virtual machine is configured to run the master network security system, and the slave virtual machine is configured to run the slave network security system. The method includes: acquiring a running state of the master virtual machine and a running state of the slave virtual machine; controlling to switch a binding/unbinding between the master virtual machine and the physical network card and between the slave virtual machine and the physical network card if it is detected that a failure occurs on the master virtual machine; and controlling the slave virtual machine to work as a new master virtual machine and controlling the master virtual machine with the failure to work as a new slave virtual machine.

With the method for controlling a physical network security device according to embodiments of the present disclosure, the running state of the master virtual machine and the running state of the slave virtual machine may be acquired, and if it is detected that the failure occurs on the master virtual machine, the network card may be controlled to be switched, the slave virtual machine is controlled to work as a new master virtual machine, and the master virtual machine with the failure is controlled to work as a new slave virtual machine. In other words, two virtual machines running respective network security system are used, such that the switching between the master virtual network security system and the slave virtual network security system may be realized inside a same physical hardware, and the availability as to the software problem is increased greatly. Further, compared with the hot-standby technology, the cost is reduced greatly. Moreover, it is transparent for the user, thus it is unnecessary to set configurations related to the high availability.

In order to achieve the above objectives, embodiments of a second aspect of the present disclosure provide a physical network security device. The physical network security device includes: a physical network card; a master virtual machine deployed on an operating system of the physical network security device and configured to run a master network security system; a slave virtual machine deployed on the operating system of the physical network security device and configured run a slave network security system; and a controller disposed on the operating system of the physical network security device and configured to: acquire a running state of the master virtual machine and a running state of the slave virtual machine; control to switch a binding/unbinding between the master virtual machine and the physical network card and between the slave virtual machine and the physical network card if it is detected that a failure occurs on the master virtual machine; control the slave virtual machine to work as a new master virtual machine and control the master virtual machine with the failure to work as a new slave virtual machine.

With the physical network security device according to embodiments of the present disclosure, the running state of the master virtual machine and the running state of the slave virtual machine may be acquired by the controller, and if it is detected that the failure occurs on the master virtual machine, the controller may control to switch the network card, control the slave virtual machine to work as a new master virtual machine, and control the master virtual machine with the failure to work as a new slave virtual machine. In other words, two virtual machines running respective network security system are used, such that the switching between the master virtual network security system and the slave virtual network security system may be realized inside a same physical hardware, and the availability as to the software problem is increased greatly. Further, compared with the hot-standby technology, the cost is reduced greatly. Moreover, it is transparent for the user, thus it is unnecessary to set configurations related to the high availability.

In order to achieve the above objectives, embodiments of a third aspect of the present disclosure provide a device for controlling a physical network security device. The physical network security device includes a master virtual machine, a slave virtual machine and a physical network card, in which the master virtual machine is configured to run a master network security system, the slave virtual machine is configured to run a slave network security system. The device includes a processor and a memory configured to store instructions executable by the processor, in which the processor is configured to: acquire a running state of the master virtual machine and a running state of the slave virtual machine; control to switch a binding/unbinding between the master virtual machine and the physical network card and between the slave virtual machine and the physical network card if it is detected that a failure occurs on the master virtual machine; and control the slave virtual machine to work as a new master virtual machine and control the master virtual machine with the failure to work as a new slave virtual machine.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a method for controlling a physical network security device according to an embodiment of the present disclosure;

FIG. 2 is a flow chart of a method for controlling a physical network security device according to another embodiment of the present disclosure;

FIG. 3 is a flow chart of a method for controlling a physical network security device according to yet another embodiment of the present disclosure;

FIG. 4 is a block diagram of a physical network security device according to an embodiment of the present disclosure; and

FIG. 5 is a block diagram of a physical network security device according to another embodiment of the present disclosure.

### DETAILED DESCRIPTION

Reference will be made in detail to embodiments of the present disclosure, where the same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

A method for controlling a physical network security device and a physical network security device according to embodiments of the present disclosure will be described below with reference to drawings.

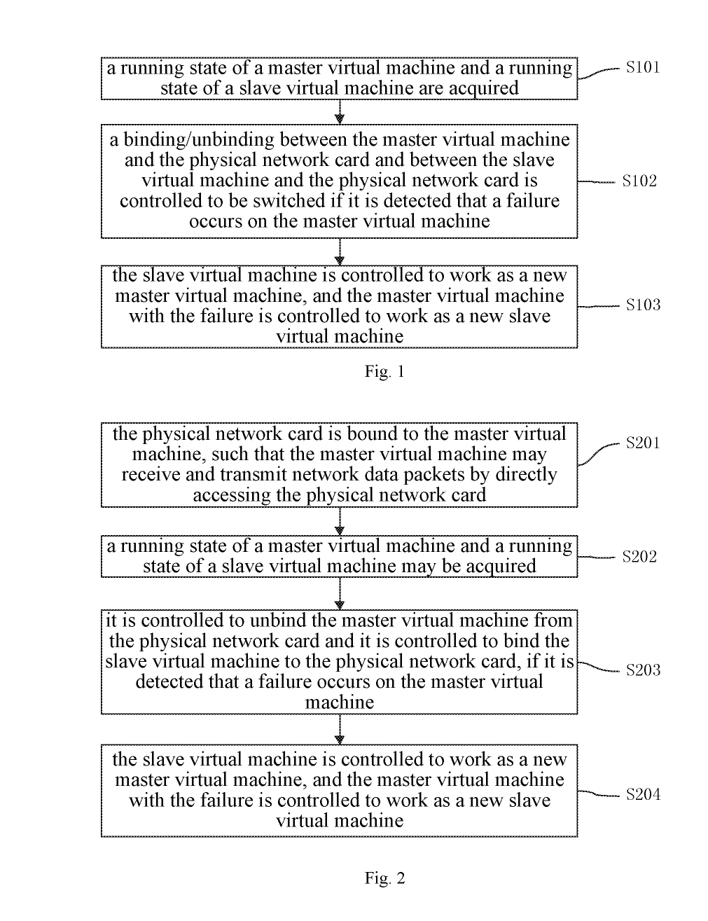

FIG. 1 is flow chart of a method for controlling a physical network security device according to an embodiment of the present disclosure. It should be noted that, in embodiments of the present disclosure, the physical network security device may include but be not limited to, a master virtual machine, a slave virtual machine and a physical network card or the like. The master virtual machine may be configured to run a master network security system and the slave virtual machine may be configured to run a slave network security system.

It should be understood that, at least two virtual machines may be deployed on an operating system of the physical network security device. Preferably, two virtual machines may be deployed, one is used as a master virtual machine and the other one is used as a slave virtual machine. A network security system may be deployed on the master virtual machine, which may be used as the master network security system. A slave network security system may be deployed on the slave virtual machine. In other words, two network security systems in a form of virtual machine may be running in the operating system of the physical network security device, one is used as a master system, and the other one is used as a slave system.

It may be understood that, either the master network security system or the slave network security system in embodiments of the present disclosure refers to a system with various network security product characteristics and security businesses of related products, such as firewall, VPN (Virtual Private Network), UTM (Unified Threat Management), IPS (Intrusion Prevention System), IDS (Intrusion Detection System), Next Generation Firewall or the like.

As shown in FIG. 1, the method for controlling a physical network security device may include the following steps.

In step S101, a running state of a master virtual machine and a running state of a slave virtual machine may be acquired.

Specifically, heartbeat messages sent by the master virtual machine and the slave virtual machine in real time may be received, such that the running state of the master virtual machine and the running state of the slave virtual machine may be acquired. It may be understood that, the transmission of heartbeat messages starts at the start-up of the master virtual machine and the slave virtual machine and goes on until the master virtual machine or the slave virtual machine is closed. The master virtual machine or the slave virtual machine continuously sends periodic messages or repeated messages during this period. If a controller for high availability disposed on the operating system of the physical network security device does not receive a message during a certain message receiving cycle, then it may be considered that the master virtual machine or the slave virtual machine is closed, or has a failure, or is unavailable currently.

In step S102, a binding/unbinding between the master virtual machine and the physical network card and between the slave virtual machine and the physical network card is controlled to be switched if it is detected that a failure occurs on the master virtual machine.

Further, before controlling to switch the binding/unbinding between the master virtual machine and the physical network card and between the slave virtual machine and the physical network card, the method may further include: acquiring how the master virtual machine or the slave virtual machine receives and transmits network data packets, determining whether the master virtual machine or the slave virtual machine receives and transmits network data packets by directly accessing the physical network card, and if yes, controlling to switch the binding/unbinding between the master virtual machine and the physical network card and between the slave virtual machine and the physical network card correspondingly.

Specifically, in embodiments of the present disclosure, if it is detected that a failure occurs on the master virtual machine, controlling to switch the binding/unbinding between the master virtual machine and the physical network card and between the slave virtual machine and the physical network card correspondingly may be implemented as follows: controlling to unbind the master virtual machine from the physical network card, and controlling to bind the slave virtual machine to the physical network card. In other words, if it is detected that a failure occurs on the master virtual machine according to the running state of the master virtual machine, and if it is determined that the master virtual machine or the slave virtual machine receives and transmits network data packets by directly accessing the physical network card, it is controlled to unbind the master virtual machine from the physical network card, and it is controlled to bind the slave virtual machine to the physical network card.

It should be noted that, in embodiments of the present disclosure, when deploying the master virtual machine and slave virtual machine on the operating system of the physical network security device via a virtualization platform, a virtual network card may be applied in the master virtual machine or slave virtual machine, and the slave virtual machine or the master virtual machine receives and transmits network data packets via a virtual switch deployed on the operating system of the physical network security device. For example, the virtual switch may receive a network data packet sent by a virtual switch (the master virtual machine or the slave virtual machine) via the virtual network card therein and transfer the network data packet to the physical network card. Or, the virtual switch may receive a network data packet sent by the physical network card and send the network data packet to the virtual network card in a virtual switch (the master virtual machine or the slave virtual machine), such that the virtual machine receives the network data packet from the virtual network card therein. The above virtual network card may be provided by the virtualization platform, and may be Vmxnet 3 card, Virtio-net card, Xenvirt card or the like.

In embodiments of the present disclosure, if it is detected that a failure occurs on the master virtual machine according to the running state of the master virtual machine, and if it is determined that the master virtual machine or the slave virtual machine receives and transmits network data packets by using a virtual network card therein rather than directly accessing the physical network card, the binding or unbinding between the physical network card and the master virtual machine and between the slave virtual machine and the physical network card is kept. In other words, since the virtual network cards in both the master virtual machine and the slave virtual machine are connected to the same virtual switch, it is unnecessary to switch the binding or unbinding between the physical network card and the master virtual machine and between the slave virtual machine and the physical network card when a failure occurs on the virtual machine.

In step S103, the slave virtual machine is controlled to work as a new master virtual machine, and the master virtual machine with the failure is controlled to work as a new slave virtual machine.

Specifically, after controlling to switch the binding or unbinding between the physical network card and the master virtual machine and between the slave virtual machine and the physical network card (for example, controlling to unbind the master virtual machine from the physical network card, and controlling to bind the slave virtual machine to the physical network card), the slave virtual machine may take the place of the master virtual machine with the failure, i.e., a message is sent to the slave virtual machine so as to inform the slave virtual machine to work as a new master virtual machine, and the operation mode of the slave virtual machine is switched to a master mode, meanwhile the master virtual machine with the failure is used as a new slave virtual machine, such that a switching is accomplished.

With the method for controlling a physical network security device according to embodiments of the present disclosure, the running state of the master virtual machine and the running state of the slave virtual machine may be acquired, and if it is detected that a failure occurs on the master virtual machine, the network card may be controlled to be switched, the slave virtual machine is controlled to work as a new master virtual machine, and the master virtual machine with the failure is controlled to work as a new slave virtual machine. In other words, two virtual machines running respective network security system are used, such that the switching between the master virtual network security system and the slave virtual network security system may be realized inside a same physical hardware, and the availability as to the software problem is increased greatly. Further, compared with the hot-standby technology, the cost is reduced greatly. Moreover, it is transparent for the user, thus it is unnecessary to set configurations related to the high availability.

Further, in an embodiment of the present disclosure, the method for controlling a physical network security device may further include: synchronizing information in the master virtual machine and the slave virtual machine, in which the information includes configuration information, running information and system time. That is, the method may support a mirror function and synchronize the configuration information, running information and system time of two virtual network security systems in the same physical device, such that the connection interruption may be avoided during the switching, thus improving the performance and availability.

FIG. 2 is a flow chart of a method for controlling a physical security network device according to another embodiment of the present disclosure.

It should be noted that, besides by accessing the virtual network card provided by the virtualization platform, the virtual machine (the master virtual machine or the slave virtual machine) may receive and transmit network data packets by binding the virtual machine to the physical network card so as to access the physical network card directly. Specifically, as shown in FIG. 2, the method for controlling a physical network security device may include the following steps.

In step S201, the physical network card is bound to the master virtual machine, such that the master virtual machine may receive and transmit network data packets by directly accessing the physical network card.

Specifically, after deploying the master network security system and the slave network security system in a form of virtual machine, the master virtual machine may be bound to the physical network card so as to access the physical network card directly, such that the master network security system may transmit and receive the network data packets by directly accessing the physical network card.

Specifically, in embodiments of the present disclosure, directly accessing the physical network card may be realized by a PCI (Peripheral Component Interconnect) transparent transmission manner or by using a SR-IOV technology. For the PCI transparent transmission manner, the virtual machine is directly bound to the physical network card, such that the virtual machine may access the physical network card. For the SR-IOV technology, a virtual function module in the physical network card is bound to the virtual machine.

In other words, directly accessing the physical network card may be realized by a PCI transparent transmission manner. In the PCI transparent transmission manner, the physical network card is bound to a corresponding virtual machine (such as the master virtual machine) directly, such that the virtual machine occupies the physical network card lonely and accesses the physical network card directly. Thus, by accessing the physical network card in a PCI transparent transmission manner, the network performance may achieve to the same level as a physical machine accessing the physical network card.

Alternatively, directly accessing the physical network card may be realized by using a SR-IOV technology. In this way, a VF (virtual function) module in the physical network card is bound to corresponding virtual machine (such as the master virtual machine), and the virtual machine is controlled to access the VF module in the physical network card directly. Thus, by accessing the physical network card using the SR-IOV technology, the network performance may achieve to the same level as a physical machine accessing the physical network card.

In step S202, a running state of a master virtual machine and a running state of a slave virtual machine may be acquired.

Specifically, heartbeat messages sent by the master virtual machine and the slave virtual machine in real time may be received, such that the running state of the master virtual machine and the running state of the slave virtual machine may be acquired. It may be understood that, the transmission of heartbeat messages starts at the start-up of the master virtual machine and the slave virtual machine and goes on until the master virtual machine or the slave virtual machine is closed. The master virtual machine or the slave virtual machine continuously sends periodic messages or repeated messages during this period. If a controller for high availability disposed on the operating system of the physical network security device does not receive a message during a certain message receiving cycle, then it may be considered that the master virtual machine or the slave virtual machine is closed, or has a failure, or is unavailable currently.

In step S203, it is controlled to unbind the master virtual machine from the physical network card and it is controlled to bind the slave virtual machine to the physical network card, if it is detected that a failure occurs on the master virtual machine.

Specifically, if a failure occurs on the master virtual machine, the failure of the master virtual machine may be detected via the acquired running state of the master virtual machine, and then a switching is triggered, i.e., the master virtual machine with the failure is unbound from the physical network card, and the slave virtual machine is bound to the physical network card.

In step S204, the slave virtual machine is controlled to work as a new master virtual machine, and the master virtual machine with the failure is controlled to work as a new slave virtual machine.

Specifically, after unbinding the master virtual machine with the failure from the physical network card and binding the slave virtual machine to the physical network card, the slave virtual machine may take the place of the master virtual machine with the failure, i.e., a message is sent to the slave virtual machine so as to inform the slave virtual machine to work as a new master virtual machine, and the operation mode of the slave virtual machine is switched to a master mode, meanwhile the master virtual machine with the failure is used as a new slave virtual machine, such that a switching is accomplished.

With the method for controlling a physical network security device according to embodiments of the present disclosure, after deploying the master network security system and slave network security system in a form of virtual machine, the master virtual machine may be controlled to access the physical card by a PCI transparent transmission manner or by using the SR-IOV technology. In this way, the network security system in a form of virtual machine may achieve the same level as a physical machine in the transmission efficiency of network data packets, thus solving the bottleneck for handling network data of a virtual machine.

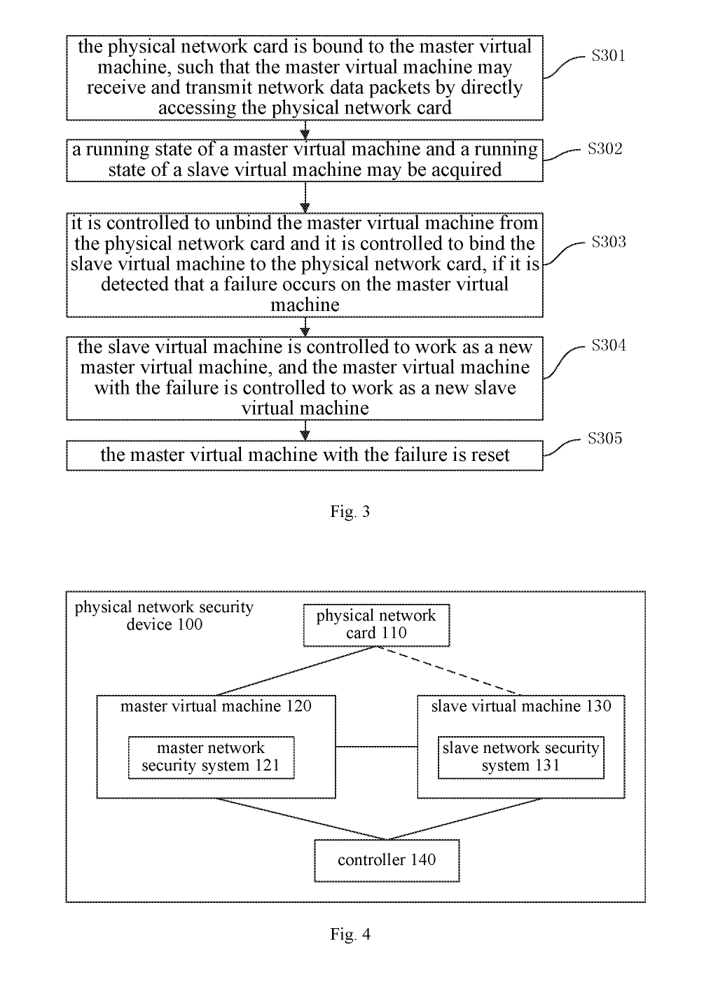

FIG. 3 is a flow chart of a method for controlling a physical security network device according to yet another embodiment of the present disclosure.

In order to further improve the performance and availability of the network security device, in embodiments of the present disclosure, after the master virtual machine with the failure is controlled to work as a new slave virtual machine, the master virtual machine with the failure is reset. Specifically, as shown in FIG. 3, the method for controlling a physical network security device may include the following steps.

In step S301, the physical network card is bound to the master virtual machine, such that the master virtual machine may receive and transmit network data packets by directly accessing the physical network card.

Specifically, after deploying the master network security system and the slave network security system in a form of virtual machine, the master virtual machine may be bound to the physical network card so as to access the physical network card directly, such that the master network security system may transmit and receive the network data packets by directly accessing the physical network card.

Specifically, in embodiments of the present disclosure, directly accessing the physical network card may be realized by a PCI (Peripheral Component Interconnect) transparent transmission manner or by using a SR-IOV technology. For the PCI transparent transmission manner, the virtual machine is directly bound to the physical network card, such that the virtual machine may access the physical network card. For the SR-IOV technology, a virtual machine is bound to a virtual function module in the physical network card, such that the virtual machine may access the physical network card.

In other words, directly accessing the physical network card may be realized by a PCI transparent transmission manner. In this way, the physical network card is bound to a corresponding virtual machine (such as the master virtual machine) directly, such that the virtual machine occupies the physical network card lonely and accesses the physical network card directly. Thus, by accessing the physical network card in a PCI transparent transmission manner, the network performance may achieve to the same level as a physical machine accessing the physical network card.

Alternatively, directly accessing the physical network card may be realized by using a SR-IOV technology. In this way, a VF (virtual function) module in the physical network card is bound to corresponding virtual machine (such as the master virtual machine), and the virtual machine is controlled to access the VF module in the physical network card directly. Thus, by accessing the physical network card using the SR-IOV technology, the network performance may achieve to the same level as a physical machine accessing the physical network card.

In step S302, a running state of a master virtual machine and a running state of a slave virtual machine may be acquired.

Specifically, heartbeat messages sent by the master virtual machine and the slave virtual machine in real time may be received, such that the running state of the master virtual machine and the running state of the slave virtual machine may be acquired. It may be understood that, the transmission of heartbeat messages starts at the start-up of the master virtual machine and the slave virtual machine and goes on until the master virtual machine or the slave virtual machine is closed. The master virtual machine or the slave virtual machine continuously sends periodic messages or repeated messages during this period. If a controller for high availability disposed on the operating system of the physical network security device does not receive a message during a certain message receiving cycle, then it may be considered that the master virtual machine or the slave virtual machine is closed, or has a failure, or is unavailable currently.

In step S303, it is controlled to unbind the master virtual machine from the physical network card and it is controlled to bind the slave virtual machine to the physical network card, if it is detected that a failure occurs on the master virtual machine.

Specifically, if a failure occurs on the master virtual machine, the failure of the master virtual machine may be detected via the acquired running state of the master virtual machine, and then a switching is triggered, i.e., the master virtual machine with the failure is unbound from the physical network card, and the slave virtual machine is bound to the physical network card.

In step S304, the slave virtual machine is controlled to work as a new master virtual machine, and the master virtual machine with the failure is controlled to work as a new slave virtual machine.

Specifically, after unbinding the master virtual machine with the failure from the physical network card and binding the slave virtual machine to the physical network card, the slave virtual machine may take the place of the master virtual machine with the failure, i.e., a message is sent to the slave virtual machine so as to inform the slave virtual machine to work as a new master virtual machine and the operation mode of the slave virtual machine is switched to a master mode, meanwhile the master virtual machine with the failure is used as a new slave virtual machine, such that a switching is accomplished.

In step S305, the master virtual machine with the failure is reset.

Specifically, after the master virtual machine with the failure is controlled to work as a new slave virtual machine, the master virtual machine with the failure may be reset by synchronizing the configuration information, running information and system time in the network security system of the new master virtual machine to it via a mirror function, so as to enable the network security system of the master virtual machine to recover to a normal state.

With the method for controlling a physical network security device according to embodiments of the present disclosure, after the master virtual machine with the failure is controlled to work as a new slave virtual machine, the master virtual machine with the failure may be reset, so as to enable the network security system of the master virtual machine to recover to a normal state, thus further improving the performance and availability of the network security device.

For implementing the above embodiments, the present disclosure further provides a physical network security device.

FIG. 4 is a block diagram of a physical network security device according to an embodiment of the present disclosure. As shown in FIG. 4, the physical network security device 100 may include: a physical network card 110; a master virtual machine 120, a slave virtual machine 130 and a controller 140.

In embodiments of the present disclosure, as shown in FIG. 4, the master virtual machine 120 may be deployed on an operating system of the physical network security device 100 and configured to run a master network security system 121; the slave virtual machine 130 may be deployed on the operating system of the physical network security device 100 and configured to run a slave network security system 131. It may be understood that, either the master network security system 121 or the slave network security system 131 in embodiments of the present disclosure refers to a system with various network security product characteristics and security businesses of related products, such as firewall, VPN (Virtual Private Network), UTM (Unified Threat Management), IPS (Intrusion Prevention System), IDS (Intrusion Detection System), Next Generation Firewall or the like.

The controller 140 may be disposed on the operating system of the physical network security device 100 and configured to: acquire a running state of the master virtual machine 120 and a running state of the slave virtual machine 130; control to switch a binding/unbinding between the master virtual machine 120 and the physical network card 110 and between the slave virtual machine 130 and the physical network card 110 if it is detected that a failure occurs on the master virtual machine 120; control the slave virtual machine 130 to work as a new master virtual machine and control the master virtual machine 120 with the failure to work as a new slave virtual machine.

Specifically, the controller 140 may receive heartbeat messages sent by the master virtual machine 120 and the slave virtual machine 130 in real time, so as to acquire the running state of the master virtual machine 120 and the running state of the slave virtual machine 130. It may be understood that, the transmission of heartbeat messages starts at the start-up of the master virtual machine 120 and the slave virtual machine 130 and goes on until the master virtual machine 120 or the slave virtual machine 130 is closed. The master virtual machine 120 or the slave virtual machine 130 continuously sends periodic messages or repeated messages during this period. If a controller for high availability disposed on the operating system of the physical network security device 100 does not receive a message during a certain message receiving cycle, then it may be considered that the master virtual machine 120 or the slave virtual machine 130 is closed, or has a failure, or is unavailable currently.

Prior to controlling to switch the binding/unbinding between the master virtual machine 120 and the physical network card 110 and between the slave virtual machine 130 and the physical network card 110, the controller 140 may be further configured to: acquire how the master virtual machine 120 or the slave virtual machine 130 receives and transmits network data packets, determine whether the master virtual machine 120 or the slave virtual machine 130 receives and transmits network data packets by directly accessing the physical network card 110, and if yes, control to switch binding/unbinding between the master virtual machine 120 and the physical network card 110 and between the slave virtual machine 130 and the physical network card 110. Specifically, if it is detected that a failure occurs on the master virtual machine, the controller 140 controls to switch the binding/unbinding between the master virtual machine 120 and the physical network card 110 and between the slave virtual machine 130 and the physical network card 110 by steps of: controlling to unbind the master virtual machine 120 from the physical network card 110, and controlling to bind the slave virtual machine 130 to the physical network card 110. In other words, if it is detected that a failure occurs on the master virtual machine 120 according to the running state of the master virtual machine 120, and if it is determined that the master virtual machine 120 or the slave virtual machine 130 receives and transmits network data packets by directly accessing the physical network card 110, the controller 140 may control to unbind the physical network card 110 from the master virtual machine 120, and control to bind the physical network card 110 and the slave virtual machine 130.

After the controller 140 controls to switch the binding or unbinding between the physical network card and the master virtual machine and between the slave virtual machine and the physical network card (for example, controlling to unbind the physical network card 110 from the master virtual machine 120 with the failure and controlling to bind the physical network card 110 to the slave virtual machine 130), the slave virtual machine 130 may take the place of the master virtual machine 120 with the failure, i.e., a message is sent to the slave virtual machine 130 so as to inform the slave virtual machine 130 to work as a new master virtual machine, and the operation mode of the slave virtual machine 130 is switched to a master mode, meanwhile the master virtual machine 120 with the failure is used as a new slave virtual machine, such that a switching is accomplished.

With the physical network security device according to embodiments of the present disclosure, the running state of the master virtual machine and the running state of the slave virtual machine may be acquired by the controller, and if it is detected that a failure occurs on the master virtual machine, the network card may be controlled to be switched, the slave virtual machine is controlled to work as a new master virtual machine, and the master virtual machine with the failure is controlled to work as a new slave virtual machine. In other words, two virtual machines running respective network security system are used, such that the switching between the master virtual network security system and the slave virtual network security system may be realized inside a same physical hardware, and the availability as to the software problem is increased greatly. Further, compared with the hot-standby technology, the cost is reduced greatly. Moreover, it is transparent for the user, thus it is unnecessary to set configurations related to the high availability.

Further, in an embodiment of the present disclosure, after deploying the master network security system and the slave network security system in a form of virtual machine, the controller 140 may control to bind the physical network card 110 to the master virtual machine 120, such that the master virtual machine 120 transmits and receives network data packets by directly accessing the physical network card 110. Specifically, after deploying the master network security system and the slave network security system in a form of virtual machine, the controller 140 may control to bind the master virtual machine 120 to the physical network card 110 so as to directly access the physical network card, such that the master network security system may transmit and receive the network data packets by directly accessing the physical network card.

Specifically, in embodiments of the present disclosure, the controller 140 may access the physical network card directly by a PCI (Peripheral Component Interconnect) transparent transmission manner or by using a SR-IOV technology. For the PCI transparent transmission manner, the virtual machine is directly bound to the physical network card 110, such that the virtual machine may access the physical network card. For the SR-IOV technology, the virtual machine is bound to a virtual function module in the physical network card 110, such that the virtual machine may access the physical network card.

In other words, directly accessing the physical network card may be realized by a PCI transparent transmission manner. In this way, the physical network card 110 is bound to a corresponding virtual machine (such as the master virtual machine 120) directly, such that the virtual machine occupies the physical network card lonely and accesses the physical network card 110 directly. Thus, by accessing the physical network card in a PCI transparent transmission manner, the network performance may achieve to the same level as a physical machine accessing the physical network card.

Alternatively, directly accessing the physical network card may be realized by using a SR-IOV technology. In this way, a VF (virtual function) module in the physical network card 110 is bound to corresponding virtual machine (such as the master virtual machine 120), and the virtual machine is controlled to access the VF module in the physical network card 110 directly. Thus, by accessing the physical network card using the SR-IOV technology, the network performance may achieve to the same level as a physical machine accessing the physical network card.

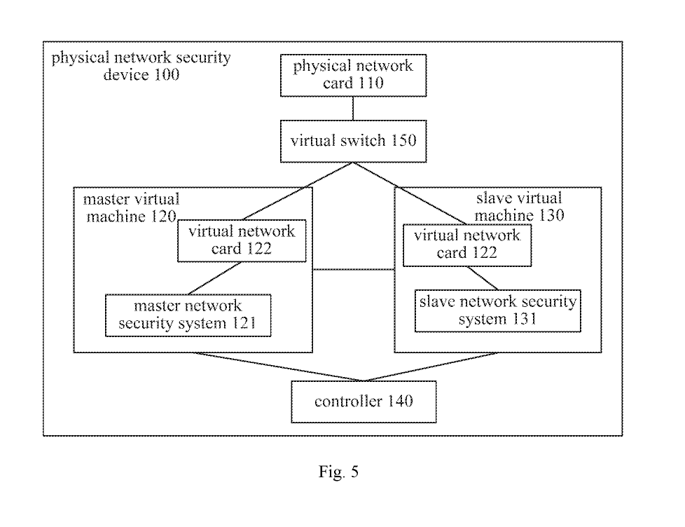

It should be noted that, besides receiving and transmitting network data packets by directly accessing the physical network card through directly binding the master virtual machine to the physical network card, the master virtual machine may receive and transmit network data packets by accessing the virtual network card provided by the virtualization platform. Further, in an embodiment of the present disclosure, as shown in FIG. 5, the physical network security device 100 may further include a virtual switch 150 deployed on the operating system of the physical network security device 100. The master virtual machine 120 may include a virtual network card 122. Take the master virtual machine 120 as an example, the virtual switch 150 may be configured to receive a network data packet sent by the master virtual machine 120 via the virtual network card 122, and to transfer the network data packet to the physical network card 110. Or, the virtual switch 150 may be configured to receive a network data packet sent by the physical network card 110, and to send the network data packet to the virtual network card 122, such that the master virtual machine 120 receives the network data packet from the virtual network card 122. In this way, the transmission and reception of network data packets is realized via the virtual network card in the virtual machine. In embodiments of the present disclosure, the virtual network card may be Vmxnet 3 card, Virtio-net card, Xenvirt card or the like. In this way, the network security system in a form of virtual machine may achieve the same level as a physical machine in the transmission efficiency of network data packets, thus solving the bottleneck for handling network data of a virtual machine.

In embodiments of the present disclosure, if the controller 140 detects that a failure occurs on the master virtual machine 120 according to the acquired running state of the master virtual machine 120, and determines that the master virtual machine 120 or the slave virtual machine 130 receives and transmits the network data packets by using a virtual network card therein rather than directly accessing the physical network card 110, the binding or unbinding between the physical network card and the master virtual machine and between the slave virtual machine and the physical network card is kept. In other words, since the virtual network cards in both the master virtual machine and the slave virtual machine are connected to the same virtual switch, it is unnecessary to switch the binding or unbinding between the physical network card and the master virtual machine and between the slave virtual machine and the physical network card when a failure occurs on the virtual machine.

Further, in an embodiment of the present disclosure, the controller 140 is further configured to synchronize information in the master virtual machine 120 and the slave virtual machine 130, in which the information includes configuration information, running information and system time. That is, the controller 140 may support a mirror function and synchronize the configuration information, running information and system time of two virtual network security systems in the same physical device, such that the connection interruption may be avoided during the switching, thus improving the performance and availability.

Preferably, in an embodiment of the present disclosure, the controller 140 is further configured to reset the master virtual machine 120 with the failure after controlling the master virtual machine 120 with the failure to work as a new slave virtual machine. Specifically, after the master virtual machine with the failure is controlled to work as a new slave virtual machine, the master virtual machine with the failure is reset according to the configuration information, running information and system time synchronized to the network security system of the master virtual machine via a mirror function, such that the network security system of the master virtual machine recovers to a normal state, thus further improving the performance and availability of the network security device.

It will be understood that, the flow chart or any process or method described herein in other manners may represent a module, segment, or portion of code that comprises one or more executable instructions to implement the specified logic function(s) or that comprises one or more executable instructions of the steps of the progress. And the scope of a preferred embodiment of the present disclosure includes other implementations in which the order of execution may differ from that which is depicted in the flow chart, which should be understood by those skilled in the art.

In the specification, it is to be understood that terms such as “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” should be construed to refer to the orientation as then described or as shown in the drawings under discussion. These relative terms are for convenience of description and do not require that the present invention be constructed or operated in a particular orientation, thus should not be construed to limit the present disclosure.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the above terms in various places throughout this specification are not necessarily referring to the same embodiment or example of the present disclosure. Furthermore, the particular features, structures, materials, or characteristics may be combined in any suitable manner in one or more embodiments or examples. Furthermore, if different embodiments or examples, and various features in the different embodiments or examples described in the specification may be combined by those skilled in the art if they are not mutually contradictory.

It will be understood that, the flow chart or any process or method described herein in other manners may represent a module, segment, or portion of code that comprises one or more executable instructions to implement the specified logic function(s) or that comprises one or more executable instructions of the steps of the progress. Although the flow chart shows a specific order of execution, it is understood that the order of execution may differ from that which is depicted. For example, the order of execution of two or more boxes may be scrambled relative to the order shown.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc. Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for controlling a physical network security device, wherein the physical network security device comprises a master virtual machine, a slave virtual machine and a physical network card, the master virtual machine is configured to run a master network security system, the slave virtual machine is configured to run a slave network security system, and the method comprises:
acquiring a running state of the master virtual machine and a running state of the slave virtual machine;
controlling to switch a binding/unbinding between the master virtual machine and the physical network card and between the slave virtual machine and the physical network card if it is detected that a failure occurs on the master virtual machine; and
controlling the slave virtual machine to work as a new master virtual machine and controlling the master virtual machine with the failure to work as a new slave virtual machine.

2. The method according to claim 1, further comprising:
acquiring how the master virtual machine or the slave virtual machine receives and transmits network data packets;
determining whether the master virtual machine or the slave virtual machine receives and transmits network data packets by directly accessing the physical network card;
if yes, controlling to switch the binding/unbinding between the master virtual machine and the physical network card and between the slave virtual machine and the physical network card correspondingly.

3. The method according to claim 2, wherein controlling to switch the binding/unbinding between the master virtual machine and the physical network card and between the slave virtual machine and the physical network card correspondingly comprises:
controlling to unbind the master virtual machine from the physical network card, and controlling to bind the slave virtual machine to the physical network card.

4. The method according to claim 2, wherein directly accessing the physical network card is realized by a PCI transparent transmission manner or by using a SR-IOV technology.

5. The method according to claim 2, further comprising:
keeping the binding or unbinding between the physical network card and the master virtual machine and between the slave virtual machine and the physical network card if the slave virtual machine or the master virtual machine receives and transmits network data packets by using a virtual network card therein.

6. The method according to claim 5, wherein the virtual network card comprises Vmxnet 3 card, Virtio-net card or Xenvirt card.

7. The method according to claim 1, further comprising:
synchronizing information in the master virtual machine and the slave virtual machine, wherein the information comprises: configuration information, running information and system time.

8. The method according to claim 1, further comprising:
resetting the master virtual machine with the failure, after controlling the master virtual machine with the failure to work as a new slave virtual machine.

9. A physical network security device, comprising:
a physical network card;
a master virtual machine deployed on an operating system of the physical network security device, and configured to run a master network security system;
a slave virtual machine deployed on the operating system of the physical network security device, and configured to run a slave network security system; and
a controller deployed on the operating system of the physical network security device, and configured to acquire a running state of the master virtual machine and a running state of the slave virtual machine, to control to switch a binding/unbinding between the master virtual machine and the physical network card and between the slave virtual machine and the physical network card if it is detected that a failure occurs on the master virtual machine, to control the slave virtual machine to work as a new master virtual machine, and to control the master virtual machine with the failure to work as a new slave virtual machine.

10. The physical network security device according to claim 9, wherein the controller is further configured to acquire how the master virtual machine or the slave virtual machine receives and transmits network data packets, and to control to switch the binding/unbinding between the master virtual machine and the physical network card and between the slave virtual machine and the physical network card correspondingly if the master virtual machine or the slave virtual machine receives and transmits network data packets by directly accessing the physical network card.

11. The physical network security device according to claim 10, wherein the controller is further configured to control to unbind the master virtual machine from the physical network card, and to control to bind the slave virtual machine to the physical network card.

12. The physical network security device according to claim 10, wherein the master virtual machine or the slave virtual machine realizes directly accessing the physical network card by a PCI transparent transmission manner or by using a SR-IOV technology.

13. The physical network security device according to claim 10, wherein the controller is further configured to keep the binding or unbinding between the physical network card and the master virtual machine and between the slave virtual machine and the physical network card if the slave virtual machine or the master virtual machine receives and transmits network data packets by using a virtual network card therein.

14. The physical network security device according to claim 13, further comprising:
a virtual switch deployed on the operating system of the physical network security device, and configured to:
receive a network data packet sent by the master virtual machine or the slave virtual machine via the virtual network card therein and transfer the network data packet to the physical network card;
or
receive a network data packet sent by the physical network card and send the network data packet to the virtual network card in the master virtual machine or the slave virtual machine, such that the master virtual machine or the slave virtual machine receives the network data packet from the virtual network card therein.

15. The physical network security device according to claim 13, wherein the virtual network card comprises Vmxnet 3 card, Virtio-net card or Xenvirt card.

16. The physical network security device according to claim 9, wherein the controller is further configured to synchronize information in the master virtual machine and the slave virtual machine, in which the information comprises configuration information, running information and system time.

17. The physical network security device according to claim 9, wherein the controller is further configured to reset the master virtual machine with the failure after controlling the master virtual machine with the failure to work as a new slave virtual machine.

18. A device for controlling a physical network security device, wherein the physical network security device comprises a master virtual machine, a slave virtual machine and a physical network card, the master virtual machine is configured to run a master network security system, the slave virtual machine is configured to run a slave network security system, and the device comprises:
a processor; and
a memory, configured to store instructions executable by the processor,
in which the processor is configured to:
acquire a running state of the master virtual machine and a running state of the slave virtual machine;
control to switch a binding/unbinding between the master virtual machine and the physical network card and between the slave virtual machine and the physical network card if it is detected that a failure occurs on the master virtual machine; and
control the slave virtual machine to work as a new master virtual machine and control the master virtual machine with the failure to work as a new slave virtual machine.
